(19) United States
(12) Patent Application Publication
(10) Pub. No.: US 2007/0230104 A1
(43) Pub. Date: Oct. 4, 2007

(54) COMPUTER ENCLOSURE WITH A SUPPORTING PLATE FOR DATA STORAGE DEVICES

(75) Inventors: YUN-LUNG CHEN, Tu-Cheng (TW); LI TONG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,116

(22) Filed: Jun. 23, 2006

(30) Foreign Application Priority Data
Mar. 31, 2006 (CN) 200620013355.5

(51) Int. Cl. G06F 1/16

(52) U.S. Cl. 361/685

(57) ABSTRACT

A computer enclosure includes a holding bracket, a supporting plate, and a front panel. A supporting structure is formed on the front panel and the supporting plate corresponding to the holding bracket. A locking structure is formed on the holding bracket and the supporting plate. The holding bracket is fixed in the computer enclosure via the supporting structure and the locking structure.

### FIELD OF THE INVENTION

The present invention relates to computer enclosures, and more particularly to a computer enclosure with a supporting plate for data storage devices.

### DESCRIPTION OF RELATED ART

When a typical personal computer is assembled, data storage devices are often attached in a computer enclosure.

A conventional computer enclosure includes a front panel and a pair of brackets which include a first bracket attached to the computer enclosure, a second bracket attached to a base plate of the first bracket, and a resilient fastener. Two generally arcuate sliding ways and three positioning portions are formed at the base plate of the first bracket. A locking aperture is defined in the base plate. Two posts and three receiving portions are formed at an upper plate of the second bracket. A locking protrusion is formed on the resilient fastener. In assembly, the posts are slidably received in the sliding ways. The receiving portions respectively engage with the corresponding positioning portions. The locking protrusion snappingly engages in the aperture. Thus, the second bracket is readily mounted to the first bracket. However, such computer enclosures have a complex structure, and cost of manufacturing is comparatively high.

What is needed, therefore, is a simple-structured computer enclosure for conveniently securing data storage devices therein.

### SUMMARY OF THE INVENTION

A computer enclosure includes a holding bracket, a supporting plate, and a front panel. A supporting structure is formed on the front panel and the supporting plate corresponding to the holding bracket. A locking structure is formed on the holding bracket and the supporting plate. The holding bracket is fixed in the computer enclosure via the supporting structure and the locking structure.

Other advantages and novel features will be drawn from the following detailed description of a preferred embodiment with attached drawings, in which:

### BRIEF DESCRIPTION OF THE DRAWINGS

FIG. 1 is an exploded, isometric view of a computer enclosure of a preferred embodiment of the present invention, the computer enclosure including a front panel, a supporting plate, and a holding bracket with a data storage device assembled thereon;

FIG. 2 is an exploded, isometric view of the data storage device and the holding bracket of FIG. 1;

FIG. 3 is similar to FIG. 1, but viewed from another aspect;

FIG. 4 is an assembled, isometric view of FIG. 1, showing the data storage device and the holding bracket in a locked position; and

FIG. 5 is similar to FIG. 4, but viewed from another aspect.

### DETAILED DESCRIPTION OF THE INVENTION

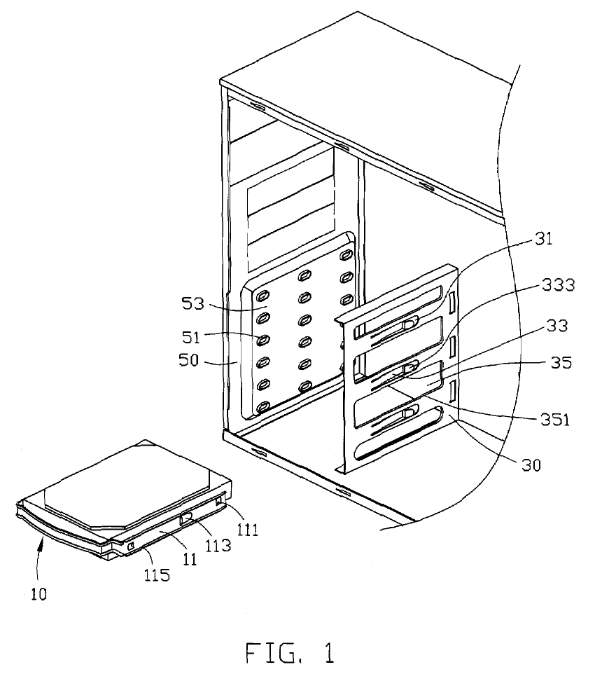

Referring to FIG. 1, a computer enclosure includes a holding bracket 10, a supporting plate 30, and a plurality of panels cooperatively constituting a chassis (only a front panel 50 of the chassis being labeled).

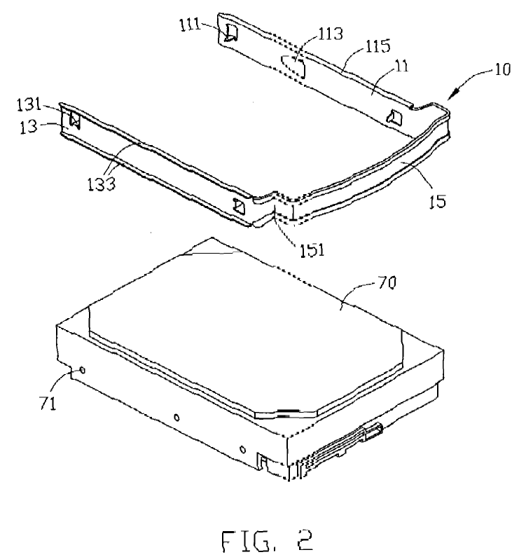

Referring to FIGS. 1 and 2, the holding bracket 10 may be a U-shaped metal frame and can accommodate a data storage device 70. The holding bracket 10 includes a first side panel 11, a second side panel 13 opposite to the first side panel 11, and a handle 15. The handle 15 connects the first side panel 11 with the second side panel 13. Two positioning tabs 111 extend inward from the first side panel 11 for inserting into positioning holes 71 at one of two opposite sides of the data storage device 70, one of the positioning tabs 111 orients horizontally for locating the data storage device 70 in the holding bracket 10 vertically, and the other orients vertically for locating the data storage device 70 in the holding bracket 10 horizontally. A block protrusion 113 is formed on an outside of the first side panel 11, between the two positioning tabs 111. Two flanges 115 are formed from a top edge and a bottom edge of the first side panel 11 respectively. Two positioning tabs 131 extend inward from the second side panel 13 corresponding to the orientation of and cooperating with, the positioning tabs 111 for mounting the data storage device 70 in the holding bracket 10. Two flanges 133 are formed from a top edge and a bottom edge of the second side panel 13 respectively. Two bent portions 151 are formed from the two opposite ends of the handle 15 respectively, and each bent portion 151 is curved downward slightly from one end of the handle 15 to connect with the corresponding side panel 11, 13. Thus, the handle 15 is in a higher position than the first side panel 11 and the second side panel 13.

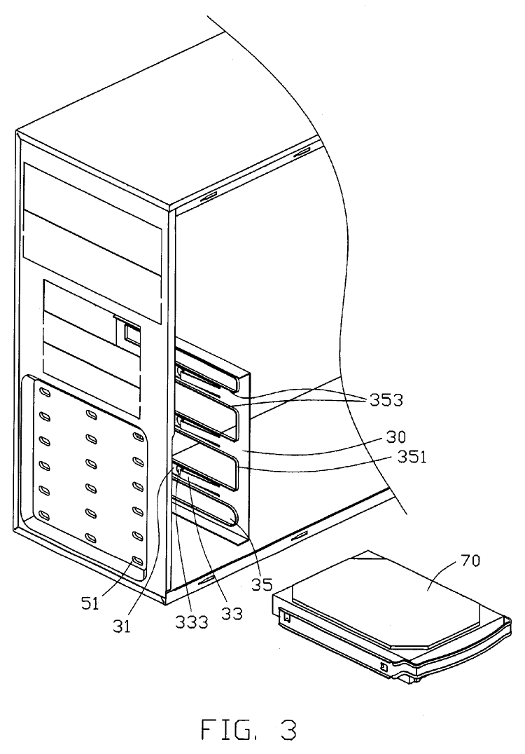

Referring to FIGS. 1 and 3, the supporting plate 30 is securely mounted within the chassis by welding or other conventional means. A plurality of parallel rectangular openings 31 is defined in the supporting plate 30. A resilient tab 33 extends inward from an end of each opening 31 and then outward to thereby form a step-shaped operating portion 333 at a free end thereof. The resilient tab 33 corresponds to the block protrusion 113 of the holding bracket 10. The resilient tab 33 and the block protrusion 113 form a locking structure. A plurality of vents 35 is defined in the supporting plate 30, each opening 31 is located between two adjacent vents 35 respectively. A loop-shaped flange 351 extends inward from the supporting plate 30 surrounding each vent 35. Horizontal adjacent portions of the flanges 351 formed at two adjacent vents 35 cooperatively form a guiding rail 353.

Three pairs of rows of guiding blocks 51 are disposed on an inner surface of the front panel 50, and each row of the guiding blocks 51 has three guiding blocks 51 arranged in a horizontal line, and each pair of rows of the guiding blocks forms a guiding way 53 corresponding to one of the guiding rails 353 of the supporting plate 30 and cooperate to form a supporting structure, the guiding ways 53 supporting the second side panel 13 and the guiding rails 353 supporting the first side panel 11 of the holding bracket 10.

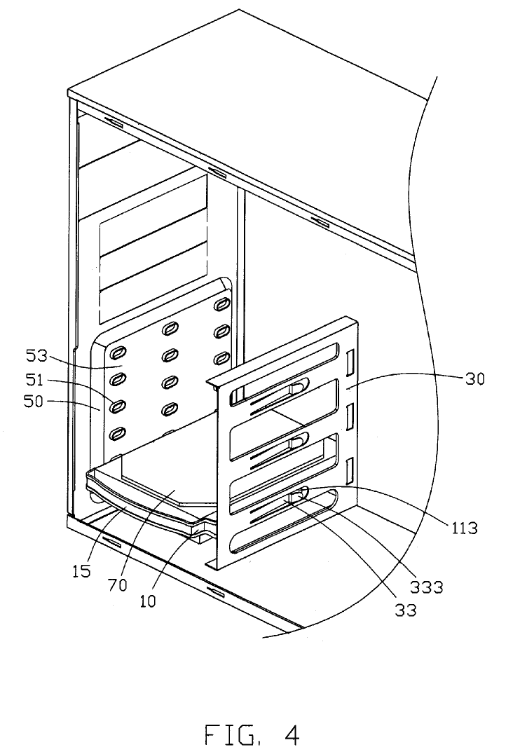

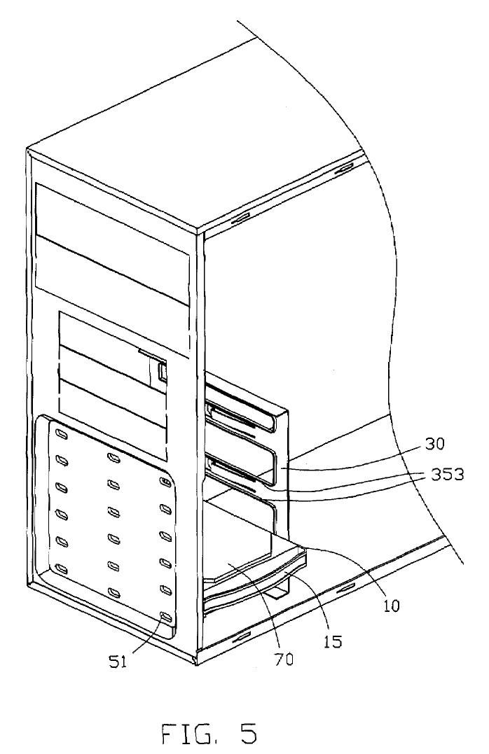

Referring to FIGS. 2 to 5, in assembly, the holding bracket 10 is fixed on the data storage device 70. The positioning tabs 111, 131 of the holding bracket 10 are inserted into the corresponding positioning holes 71 of the data storage device 70 for securing the data storage device 70 in the holding bracket 10. By use of the handle 15, the holding bracket 10 is pushed horizontally along one of the guiding rails 353 and the corresponding guiding way 51. The first side panel 11 of the holding bracket 10 is supported by the guiding rail 353 of the supporting plate 30, and the second side panel 13 of the holding bracket 10 is supported by the guiding way 51 of the front panel 50. The holding bracket 10 is further pushed inward. The resilient tab 33 of the supporting plate 30 is pushed outward by the block protrusion 113 of the holding bracket 10. When the whole holding bracket 10 is inserted into the computer enclosure, and the block protrusion 113 of the holding bracket 10 passes the step of the operating portion 333 the resilient tab 33 completely, the resilient tab 33 rebounds to its original position, and the step of the operating portion 333 of the resilient tab 33 resists against the block protrusion 113 of the holding bracket 10. Thus, the holding bracket 10 assembled the data storage device 70 is locked between the supporting plate 30 and the front panel 50 in the computer enclosure.

In disassembly, pulling the operating portion 333 of the resilient tab 33 outward releases the block protrusion 113 of the holding bracket 10. The holding bracket 10 along with the data storage device 70 is then drawn out of the computer enclosure horizontally.

It is to be understood, however, that even though numerous characteristics and advantages have been set forth in the foregoing description of preferred embodiments, together with details of the structure and function of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A computer enclosure, comprising:
a holding bracket for holding a data storage device;
a supporting plate; and
a panel, a supporting structure formed on the panel and the supporting plate for receiving the holding bracket, and a locking structure formed on the holding bracket and the supporting plate for securing the holding bracket in the computer enclosure.

2. The computer enclosure as claimed in claim 1, wherein the supporting structure comprises a plurality of guiding ways formed on the front panel, and a plurality of guiding rails on the supporting plate.

3. The computer enclosure as claimed in claim 2, wherein the guiding ways comprise several rows of guiding blocks, and each row of guiding blocks further comprises several guiding blocks arranged in a horizontal line.

4. The computer enclosure as claimed in claim 2, wherein the supporting plate defines a plurality of flanges, and each flange has at least a horizontal portion.

5. The computer enclosure as claimed in claim 4, wherein a pair of adjacent horizontal portions of the flanges forms the guiding rail.

6. The computer enclosure as claimed in claim 1, wherein the locking structure comprises a block protrusion formed on the holding bracket and a resilient tab formed on the supporting plate.

7. The computer enclosure as claimed in claim 6, wherein the resilient tab comprises a step-shaped operating portion, and the holding bracket is locked in the computer enclosure by the operating portion blocking the block protrusion.

8. The computer enclosure as claimed in claim 1, wherein the holding bracket is U-shaped and has a handle for conveniently pushing and drawing the holding bracket.

9. A mounting assembly, comprising:
a holding bracket for holding a data storage device;
a computer enclosure, the computer enclosure comprising:
a front panel; and
a supporting plate opposite to the front panel, a supporting structure formed on the computer enclosure for supporting the holding bracket between the front panel and the supporting plate, and a locking structure formed on the holding bracket for engaging with the computer enclosure thereby securing the holding bracket in the computer enclosure.

10. The mounting assembly as claimed in claim 9, wherein the supporting structure is formed on the front panel and the supporting plate.

11. The mounting assembly as claimed in claim 10, wherein the supporting structure comprises a plurality of guiding ways formed on the front panel, and a plurality of guiding rails formed on the supporting plate.

12. The mounting assembly as claimed in claim 11, wherein the guiding ways comprise several rows of guiding blocks, and each row of guiding blocks further comprises three guiding blocks arranged in a horizontal line.

13. The mounting assembly as claimed in claim 12, wherein the supporting structure further comprises a plurality of guiding rails formed on the supporting plate.

14. The mounting assembly as claimed in claim 11, wherein the supporting plate defines a plurality of flanges, and each flange has at least one horizontal portion.

15. The mounting assembly as claimed in claim 14, wherein a pair of adjacent horizontal portions of the flanges forms the guiding rail.

16. The mounting assembly as claimed in claim 9, wherein the locking structure comprises a block protrusion formed on the holding bracket and a resilient tab formed on the supporting plate.

17. The mounting assembly as claimed in claim 16, wherein the resilient tab comprises an operating portion, and the holding bracket is locked in the computer enclosure by the operating portion blocking the block protrusion.

18. A computer enclosure comprising:
a plurality of panels cooperatively constituting a chassis;
a supporting plate installed within the chassis and being parallel to one of the panels;
a holding bracket configured for slidably mounting a data storage device to the chassis;
a pair of guiding structures formed on said one of the panels and the supporting plate and configured for guiding the holding bracket sliding between said one of the panels and the supporting plate;
a resilient tab formed at one of the guiding structures and configured for interlocking with the holding bracket to thereby lock the holding bracket in the chassis.

19. The computer enclosure of claim 18, wherein the holding bracket comprises a block protrusion formed at on outside thereof, and the resilient tab has a step-shaped operating portion formed at a free end thereof, the step-shaped operating portion stopping the block protrusion to prevent the holding bracket from sliding out away from the chassis.

20. The computer enclosure of claim 19, wherein the resilient tab extends inward from one portion of the supporting plate and then outward to thereby form the step-shaped configuration.
